(19) United States
(12) Patent Application Publication
(10) Pub. No.: US 2020/0078147 A1
(43) Pub. Date: Mar. 12, 2020

(54) Individually Adaptable Dental Impression Tray for Dental Fine Impression

(71) Applicant: Sebastian LINZEN, Mönchengladbach (DE)

(72) Inventor: Sebastian LINZEN, Mönchengladbach (DE)

(21) Appl. No.: 16/615,874

(22) PCT Filed: May 28, 2018
(86) PCT No.: PCT/DE2018/100517

§ 371 Date: Nov. 22, 2019

(30) Foreign Application Priority Data
May 29, 2017 (DE) 10 2017 111 592.7

(51) Int. Cl. A61C 9/00

(52) U.S. Cl. CPC A61C 9/0006

(57) ABSTRACT

An individually adaptable impression tray for dental fine impression is formed substantially from a thermoplastic material which in the heated state permits adaptive forming of the impression tray in the mouth of a patient. At least in partial regions in which a fine impression is to be made the impression tray has a spacer layer of a predetermined thickness, wherein the spacer layer is completely or partially removable after the forming operation.

The present invention concerns an individually adaptable impression tray for dental fine impression, also components of the tray and a method of preparing such a tray for fine impression, as set forth by the features of the independent claims.

Dental impressions represent the basis for the work of the dental technician in the preparation of a dental prosthesis, that is to say in particular dental crowns, bridges, partial and complete prostheses or the like. Good quality of the impression represents the crucial prerequisite for a dental prosthesis which has an optimum fit and function. According to the state of the art the dentist takes an impression (that is to say he produces a negative shape of the patient bite or the patient jaw) by materials on an alginate, polyether or silicone base and with the use of an impression tray.

Negative shapes can then be cast with special dental gypsums or other suitable materials (plastics and so forth). The positive shape resulting therefrom then represents the working base for the dental technician.

In addition there is also the possibility of scanning and digitising the impression. That then gives a virtual model and that can be milled if desired.

The current procedure for the production of high-grade impressions requires the patient to attend a number of sessions, in which respect in general a number of dispatches between the dental practice the laboratory are also required.

According to the state of the art the dentist firstly takes a so-called first impression based on an alginate impression material for the relevant jaw (upper and/or lower jaw). Alginate is a material which is comparatively inexpensive—in contrast to the materials for the later fine impression—and in respect of which relatively large amounts as are required for that first impression can be economically used. A disadvantage with alginate however is its lack of dimensional stability—in particular depending on the degree of moisture—so that it is not possible therewith to produce particularly precise and long-lasting impressions.

Furthermore, various faults can occur when using alginate, thus for example an incorrect water/powder ratio, so that the ideal consistency is not achieved and the result is falsified. Furthermore faulty manual stirring of the mass can lead to an excess of air incorporated into the material so that in the later impression operation bubbles can occur or the resulting mixture blending is not correct so that the material is of a lumpy consistency and poor defective impression is the result.

The mixed alginate mass is generally spread into a metallic impression tray and that is then pressed into the mouth of the patient by means of a handle. The dentist or the corresponding assistant (for brevity referred to hereinafter as the “operator”) has previously selected from a series of available impression trays of different dimensions, the tray which is most suited to the patient.

Apart from the above-described negative aspects of the alginate that first impression is also frequently sub-optimal for the reason that a conventional metal tray does not permit a uniform spacing between jaw and teeth and does not guarantee omission of the bands that the patient has so that an impression cannot be taken ideally at all locations.

In addition when using conventional rigid tray bodies there is the danger of injuring the mucous membrane of the mouth in the impression procedure.

The first impression procedure is also perceived by many patients as being extremely unpleasant. That is due on the one hand to the fact that the metallic impression trays which are conventionally used generally project relatively greatly and are therefore found by the patient to be “bulky” and “clumsy” and also perceived as unpleasant by virtue of the contact with the metal which is generally perceived as being cold. On the other hand, with conventional first impressions, the patient has to hold the mouth open and in that situation saliva has to be regularly sucked away and in many patients that results in an unpleasant gagging reflex with the risk of vomiting. In addition an operator has to firmly hold the impression tray by the handle for a relatively long time in order to fix the position thereof in the mouth, whereby working time is tied up and in addition there is the risk of accidental displacements of the impression tray.

The first impression obtained in that way is then sent to the laboratory and a positive cast or model is produced therefrom. On the basis of that model the dental technician then produces from a plastic (or another suitable material) a so-called individual tray (with the existing remaining teeth) which in the case of a toothless patient is also referred to as a “functional tray”. Impressions for functional trays are always also intended to be included hereinafter, even if that is not always mentioned. There are various methods in the state of the art, inter alia a deep drawing procedure, for producing an individual tray of that kind.

The individual tray—generally provided with a handle—then goes back to the dentist who in a further session with the patient carries out a so-called second or fine impression of the structures which are relevant to the prosthesis (individual teeth, a plurality of teeth, entire rows of teeth or tooth-less jaw portions), on the basis of which the prosthesis or another kind of denture is to be produced. For that purpose the individual tray is provided with a runny silicone or polyether material and thus the fine impression is taken which is then again sent back to the dental laboratory—fixedly connected to the individual functional tray—.

In addition in accordance with the state of the art (in a further step) a so-called bite register is frequently produced to permit the jaw relationship to be determined. For that purpose the patient is asked to bite into a wall of special plastic or wax which is placed on a base adapted to the jaw (generally comprising plastic, shellac or other materials). The bite register is then also sent to the dental laboratory and there permits alignment of the casts of the upper and lower jaws in the so-called articulator (jaw joint simulator) in order to imitate the relationship of the two jaws of the patient situation. Further working steps in the laboratory and further transport there as well as generally also an additional patient session are required for the bite register.

The described procedure is very work- and time-intensive both for the dentist, the patient and the laboratory. Simplified methods do exist, which however are generally inferior in terms of the quality of the result.

In the more recent past dental materials based on low-melting thermoplastic plastics have been developed. That material is molten at such low temperatures or is already deformable inelastically (somewhat like plasticine) at such low temperatures (that is to say even lower) and in addition is biocompatible, that shaping of the thermoplastic material—which for example is previously heated in a water bath—is possible in the mouth of the patient, even if only during relatively short periods of time in which the element to be shaped is still at temperatures which permit deformability, wherein those temperatures on the other hand are so low that contact of the material with oral cavity structures of the patient is still comfortable for the patient.

In that respect the thermoplastic material can certainly be heated (for example in a water bath) to relatively high temperatures of between 70° and 100° C. If the material were at such surface temperatures upon adaptation in the mouth of the patient that would no longer be acceptable to the patient. The thermal conduction and thermal storage capabilities of the material in conjunction with a certain surface cooling prior to and after insertion of the heated material in the mouth of the patient however has the result in practice that the surface temperatures of the material in the mouth of the patient in the deformable state reach no more than typically 38° C. (an acceptable range is between 35° C. and 41° C.), even if the material were previously heated to 70° to 100°.

The above-described plasticization process is basically reversible, that is to say the material can be repeatedly heated and deformed in the heated state. In the cooled state the material is dimensionally stable and is very suitable for dental impressions. In particular the material in the cooled state is not brittle as is for example the detrimental property of cooled wax.

It has already been proposed that such thermoplastic materials be used for the production of individual impression trays. Those material however are less suitable for direct fine impression as the plasticity in the heated state is limited (by virtue or its viscosity the material rather permits “kneading”, but not molding-like impression) and removal of the cooled material and material which is closely shaped to the tooth structures from the jaw of the patient would be problematic by virtue of the undercut configurations to be found in the jaw.

WO 2008/102251 A1 describes an individual tray of that kind comprising a thermoplastic material, in which respect in particular the details in that document relating to possible materials are also to be made by reference thereto subject-matter of the present application. That tray is heated in a water bath and transformed by the operator in the mouth of the patient so that on the one hand this gives adaptation to the individual bite while on the other hand there still remains sufficient space for introducing a usual material, for example a silicone or polyether material, for a fine impression which is to be performed in a further step. This means that the thermoplastic material is not adaptively shaped to the teeth or jaw structures in large regions for otherwise there would in fact be no free space available for the fine impression material. Thus, in the case of the known individual tray, the extent to which the tray permits high-quality fine impressions to be made depends greatly on the skill of the operator. If the dentist leaves too little space the impression material cannot be uniformly distributed; if in contrast he leaves an excessively large space then an unnecessarily large amount of impression material is required. In that respect the work of the operator is additionally made more difficult by virtue of the fact that the time window for shaping the heated thermoplastic tray is quite short. Admittedly, fresh heating is possible, but that involves a waste of time and entails the risk that the tray is unwantedly deformed by additional removal and re-fitment of the tray.

In regard to the thermoplastic materials which can be used in connection with the present invention attention is further directed by way of example to the details in U.S. Pat. No. 5,415,544 A—without that being intended to constitute a limitation to given materials or types of material.

The object of the present invention is to propose an impression tray and corresponding components thereof as well as a preparation method for a fine impression with such a tray, in which the foregoing problems do not occur and it is possible to achieve a high-quality fine impression with minimal time and commercial involvement as well as reproduceably and affording improved patient comfort.

That object is attained by means of an individually adaptable impression tray having the features of claim 1 and by means of thermoplastic base element, a spacer layer and a bite wall for such an impression tray as set forth by the features of claims 18 through 20; and further by a method of preparing an individually shaped dental impression tray having a spacer layer in accordance with the features of claim 21.

Advantageous configurations of the invention are recited in the appendant claims.

In accordance with the invention there is proposed an individually adaptable impression tray for dental fine impression, wherein the impression tray is substantially formed from a thermoplastic plastic which in the heated state permits adaptive forming in the mouth of the patient (which is bearable for the patient in spite of possible direct contact of the heated material with teeth and/or oral cavity) and which is stable in shape in the cooled state. The molten state of the thermoplastic material is thus already achieved at low temperatures and the deformable state is achieved at still lower temperatures (typically with tactile surface temperatures in the mouth of the patient of not more than about) 41°, which permit adaptive forming of the impression tray in the mouth of a patient.

That impression tray is to have a spacer layer of a predetermined thickness at least in partial regions in which a fine impression is to be taken, wherein the spacer layer is removable after the forming operation. The spacer layer thus forms a kind of place holder for the material of the fine impression and thus when the impression tray (with the spacer layer) is applied against the structures from which the impression is to be taken, it ensures a defined minimum layer thickness for the fine impression material after at least partial removal of the spacer layer. The spacer layer is applied at least in partial regions of the impression tray, that is to say at least in the regions in which a fine impression is wanted, in which respect there too the spacer layer does not have to be present everywhere, see the description hereinafter relating to “stops”.

In that respect in a preferred embodiment the spacer layer can be of a thickness of between 0.1 and 50 mm, wherein that preferably constant or possibly also variable thickness is adapted to the desired minimum layer thickness of a runny impression material which is to be introduced after removal of the spacer layer for the fine impression.

In that respect the spacer layer can preferably be formed from a material which is not thermoplastic in the application temperature range but which is generally deformable in non-destructive fashion.

The spacer layer can be formed in particular from a film-like material, wherein the film must be of a suitable thickness and nonetheless must enjoy sufficient flexibility for the forming operation in the mouth of the patient, which could generally be achieved by a foamed material, for example in the manner of foam rubber, or by a possibly multi-layer metal film, for example an aluminum film or a zinc film, which is provided with a suitable protective coating.

In addition however many other, possibly multi-layer constructions are also conceivable for the spacer layer. It is for example also conceivable that the spacer layer is formed substantially from the thermoplastic material of the impression tray itself and is separated only by a thin layer of a separation material from the actual impression tray so that the spacer layer can be definedly removed.

The spacer layer can be glued to the impression tray, in which case the adhesive can be for example an adhesion adhesive so that the spacer layer can be sufficiently easily pulled off as far as possible without leaving a residue. It would also be conceivable that the spacer layer is of a certain chemical sensitivity in relation to external influences, which the material of the impression tray does not likewise have, in order thereby to remove the spacer layer by stipulating physical or chemical conditions. For example the spacer layer could be particularly sensitive in relation to certain chemicals (non-toxic for the further steps) like acids or lyes, or could break down under the action of electromagnetic radiation—like for example UV radiation—or could at least compact down, that is to say see a reduction in its layer thickness; for example by virtue of the escape of incorporated gas constituents under a temporary vacuum influence. The latter compacting is also to be deemed in accordance with the present invention to be “at least partial removal”.

An advantageous configuration provides that the spacer layer can be removed easily and as residue-free as possible from the thermoplastic material, which can be facilitated by virtue of a suitable configuration of the interface between the spacer layer and the thermoplastic material, for example—as already mentioned—by a releasable adhesive or adhesion glue and/or siliconization of the glue counterpart surface, that facilitates detachment.

The spacer layer is preferably so tear-resistant that it can be detached by an operator or another person after the forming operation in the mouth of the patient in one piece or at least in a number of defined pieces without serious residues remaining on the thermoplastic material. The tearing strength properties can be implemented when using materials which in themselves are at risk of tearing—like paper or thin metal films—for example by additional plastic layers which are laminated in place or glass fiber reinforcements in the spacer layer material.

In an embodiment it can also be provided that the thermoplastic material and the spacer layer are separated from each other by a film or another flat fabric material, in which respect the film or the like remains on the thermoplastic material after removal of the spacer layer. In that case that film or the like does not belong to the spacer layer but to the rest of the impression tray which in fact is to be formed not completely but only substantially from the described thermoplastic material.

The expression “formed substantially from a thermoplastic material” is intended moreover to mean at least 50%, but preferably more than 80%, and particularly preferably 90% to 100% by weight of said thermoplastic material.

The spacer layer can further advantageously have the following properties:

the spacer layer can provide a certain stabilizing function for the heated thermoplastic material of the tray base, which provides the heated tray with improved stability and easier handling. For example the spacer layer can include an inelastically deformable film (for example a metal film), with which a certain basic form can be modeled on the tray, which form then upon handling and insertion of the tray in the mouth of the patient is retained better than would be the case when inserting the pure thermoplastic tray;

advantageously the spacer layer does not have any (noticeable) recovery characteristic, that is to say once pressure is applied to the spacer layer it remains in the defined position and does not push for example the thermoplastic material which is shaped/pressed thereon away from the target structure again;

furthermore the spacer layer on the side towards the thermoplastic material can be colored and/or can have inscriptions and/or patterns thereon. That involves the technical background that, in the case of a transparent thermoplastic material, optical transparency or degree of opacity regularly changes with the degree of plasticity, so that those optical properties represent an indicator for the current temperature and thus shapability of the thermoplastic material. By virtue of coloring of the “inside” of the spacer layer or the provision with a pattern or labeling the degree of transparency can be particularly well seen by the operator, and for that reason the spacer of that configuration has an additional “indicator action”.

In order to ensure a reproducible position of the impression tray in the fine impression operation even without the supporting effect of the spacer layer which is then at least partially removed an advantageous configuration of the invention can provide that the spacer layer for producing one or more so-called stops has at least one and preferably at least three openings, through which the thermoplastic material of the impression tray can pass directly to the tooth or jaw structures from which the impression is to be taken.

Thus in the forming operation the thermoplastic material can pass through those openings and thus form fixing abutments or stops which even after the removal of the spacer layer ensure a reproducible position for the impression tray so that the free space achieved by the spacer layer is uniformly available with a predetermined minimum thickness.

In order to ensure that the thermoplastic material in the adaptive forming operation is actually pressed against the tooth or jaw region in the region of the at least one opening the impression tray can be preformed in a raised configuration in the region of the openings so that a certain amount of thermoplastic material comes into contact directly with the application points without firstly having to push through the openings in the spacer layer.

Alternatively, for a part of or for all stops, the spacer layer for producing one or more stops can also have recesses which do not pass completely therethrough, through which the thermoplastic material of the impression tray cannot come into direct contact but can pass at least closer to the tooth or jaw structures from which the impression is to be taken, than in surrounding regions. For example the spacer layer which is of a certain predetermined thickness for forming the stop may have a hole which however is closed off with a thin film in relation to the jaw structures from which the impression is to be taken. The thermoplastic material then projects into that opening and comes closer to the jaw structures to be modeled, but does not bear directly against them.

It is also conceivable that the stops or the corresponding openings, besides a substantially circular structure, are also in the form of grooves or predetermined geometrical patterns.

Preferably there can be at least three stops for an upper jaw impression tray and at least four stops for a lower jaw impression tray, wherein preferably at least one stop is respectively provided in the two lateral regions of the dental arch from which the impression is to be taken and at least one stop in the central front (ventral) region of the dental arch. In that respect the possibility should not be excluded that the stops or openings in the spacer layer are in the regions provided for fine impression. If the openings are provided for example in a region which in the impression-taking operation is disposed substantially opposite the chewing surfaces of given teeth then those stops in the later fine impression operation for those teeth form a constituent part of the fine impression, which represents no problem in such relatively small regions. Therefore the spacer layer also does not necessarily have to extend over the entire structures from which a fine impression is to be taken, but in particular there too can have openings for the formation of stops.

Those stops can already be provided in the tray base from the factory or can be subsequently individually added by the operator (glued or “fused” to the tray base) so that it is possible to cater even more individually for the situation of the patient.

The stops can also comprise the thermoplastic material, in which case the surrounding spacer layer ensures that the stops are not or are only slightly deformed in the forming operation, or alternatively the stops can comprise another material which is not thermoplastically deformable at the relevant temperatures, and for example are glued to the corresponding locations by the operator by means of a self-adhesive layer prior to the fine impression operation.

Furthermore one or more retention elements can be provided in the thermoplastic material and/or the spacer layer for fixing the fine impression layer which is to be later introduced in relation to adjoining impression tray structures upon later removal of the tray after the fine impression has been taken. Desirably that is achieved by suitable recesses or openings in the spacer layer on the side towards the thermoplastic material; it is however also possible to provide pin-like protrusions on the spacer layer, or said structures can also have other shapes like for example grooves or a geometrical pattern. Optionally the above-described stops—depending on the respective positioning thereof—also act as a retention structure. The thermoplastic material even after removal of the spacer layer then has a negative structure in relation to the retention structures of the spacer layer, that is to say either protrusions or recesses. They provide for good adhesion of the fine impression in the thermoplastic material so that it is possible in that case to optionally dispense with the introduction of an additional bonding agent prior to taking the fine impression.

In an embodiment of the invention it is preferred if the spacer layer extends substantially—except for possible openings for stops—over the entire region facing towards the upper or lower structures which are to have the impression taken, wherein the spacer layer in the non-adapted state of the impression tray can laterally project beyond same.

By virtue of that lateral projection it is possible to ensure that upon adaptive forming of the thermoplastic material the plastic does not swell beyond the edge of the spacer layer. In addition, by virtue of the projecting place holder film, the operator also has the option of achieving an edge prolongation of the edge of the tray by pressing against the thermoplastic material so that all important anatomical structures are reliably engaged, in particular the membrane fold and the A-line.

With the spacer layer being of such an almost full-surface configuration that has the advantage that it provides an insulation effect in relation to the moderate heat of the thermoplastic material, which however is possibly nonetheless unpleasant in relation to sensitive teeth.

In addition a flexibly compressible material like for example a foam or a rubber foam facilitates removal of the cooled impression tray after the forming operation in the mouth as the spacer layer can flex upon withdrawal in relation to structures of undercut configuration. Moreover, depending on how greatly the operator adaptively forms the impression tray in the region of the tooth neck, he can also influence how easily the impression tray can be removed again, for the spacer layer in fact only guarantees a minimum spacing which in certain regions can also be made intentionally larger by the operator by not completely adaptively forming the thermoplastic material with the spacer layer.

In this connection it is also conceivable that, when the spacing is to be greater from the outset for given regions (for example in the region of a tooth neck for easier removability), the spacer layer per se in those regions is of a greater thickness than in other regions.

In an alternative configuration of the invention defined perforations can be provided in the thermoplastic plastic of the impression tray at least in partial regions, which perforations can be covered over by the spacer layer. Excess fine material can later escape into those perforations in the fine impression operation (with the spacer layer then being removed). The perforations can be provided for example on the side towards the jaw from which the impression is to be taken, in approximately equal spacings, in the form of a regular matrix, in which case the diameter and the depth are only a few millimeters so that not too much impression material can escape. In the forming process of the thermoplastic material the perforations are possibly somewhat deformed, but remain generally operational. Those structures also act as retention elements as described hereinbefore.

It is optionally possible for “deformed” and possibly closed perforations in the hardened state of the thermoplastic to be opened again for example with a milling cutter or another instrument suitable for that purpose.

If there should be greatly undercut regions in the mouth of the patient then they can additionally be blocked out intraorally with a special material, for example with a special wax or kneading material. Subsequently the heated tray is then fitted thereover and adapted thereto.

To easily insert the impression tray into the mouth and in particular in order to be able to easily “lever it out” after the adaptive forming operation and after the fine impression has been taken then—similarly to the known conventional impression trays of metal—it can have a detachable tray handle connected to the impression tray, which is made either from the thermoplastic plastic of the impression tray or from another material. If the tray handle is made from the same thermoplastic material then it should desirably not be heated or at least not so greatly heated therewith. Alternatively the tray handle can be made from another material, for example a plastic which has a markedly higher melting point, in which case the tray handle can be incorporated into the material of the impression tray and anchored therein. Alternatively the tray handle can also be subsequently releasably fixable to the impression tray—for example by means of screws or a push-in or latching connection—. That is appropriate in particular when the tray handle is to be fitted in particular for the fine impression step because in that case somewhat greater forces sometimes have to be applied for removal of the impression tray, than in the previous adaptive forming step.

In order also to be able to carry out an operation for determining jaw relationship with the impression tray according to the invention—by virtue thereof it is then optionally possible to save on a complete patient session in relation to the conventional procedure—it can be provided that the impression tray is adapted for fixing a bite wall, fixing being effected on the side remote from the respective impression side. The bite wall can be formed from the thermoplastic plastic material of the impression tray or from another inelastic material (that is to say being inelastically deformable by the bite action).

The bite wall is preferably fixed on the impression tray after implementing the fine impression. In the case of an impression tray for the lower jaw that is effected on the top side so that the bite impression of the upper jaw can be taken, and conversely in the case of an impression tray for the upper jaw a bite impression of the lower jaw is registered. If the bite wall is formed from a thermoplastic material which also has a low melting point then the entire impression tray with fitted bite wall can be heated once again and then the bite impression can be taken, which can also dig into the material of the impression tray. The bite wall then remains intimately connected to the impression tray and can serve to reconstruct the relative position as between the upper jaw and the lower jaw in an articulator in the dental laboratory.

Furthermore in accordance with the invention there is proposed a thermoplastic base element which includes at least the impression tray of thermoplastic plastic with or without the tray handle but without the spacer layer, wherein the base element is adapted for applying a spacer layer prior to the adaptive forming operation, possibly with presetting of suitable positions for stops. Application of the spacer layer can then be effected prior to the corresponding forming operation, possibly also only in the regions in which a fine impression is required.

In a preferred configuration, at the side opposite to the jaw structures from which the impression is to be taken, the impression tray has regions which in the deformable state of the plastic can be deformed by the opposite jaw bite in such a way that a reproducible position of the impression tray for a later fine impression step is defined thereby. This means that at the location of the counter-bite the impression tray generally has a flat surface and comprises sufficiently thermoplastic material which can receive the bite impression.

That feature permits a particularly advantageous impression procedure in which the patient can keep the mouth substantially closed during the hardening time of the fine impression material and there is no need for the operator to hold it fixed. More specifically, by virtue of the bite impression of the opposite bite, additional fixing of the tray in the mouth is made possible in the fine impression operation if the patient bites again into that bite impression during the fine impression procedure. In that way the fine impression becomes on the one hand more pleasant for the patient as the gagging reflex with the mouth substantially closed is eliminated or reduced; which is substantially due to the fact that the patient can independently swallow normally with the mouth closed. In addition there is the general advantage of the impression tray according to the invention that it can be better adapted to the jaw geometry and projects less. In addition there is a saving in terms of working time by the fact that an operator no longer has to hold the impression tray fixedly in place. Optionally the patient can even leave the dentist chair during the hardening phase of the impression material, which hitherto is not usually the case.

An addition significant advantage of this fine impression method is that, by virtue of the fact that the patient can bite shut during the hardening phase a (physically) optimum contact pressure is exerted on the fine impression material. Such a pressure could in fact not be exerted by an operator so uniformly and intensively.

To permit or facilitate the above-explained opposite jaw bite impression the impression tray at the side opposite the jaw structure from which the impression is to be taken can have a separation layer at the surface or near the surface at least in partial regions. That can involve for example a glued fabric layer (for example woven gauze).

Such an additional separation layer has the following functions or advantages:

penetration of thermoplastic material into interdental spaces of the opposite jaw in the counter-bite is avoided, which otherwise would make removal of the impression tray after adaptive forming painful for the patient;

completely biting through the thermoplastic material by the opposite jaw is prevented. Such a biting effect could more specifically result in “leakage” of fine impression material in the later fine impression process;

the teeth which are particularly more heat-sensitive in comparison with the other oral cavity structures are insulated from the effect of temperature of the thermoplastic material which is possibly still somewhat hotter.

Furthermore in accordance with the invention there is proposed a spacer layer which is adapted for releasable application to a thermoplastic base element as described hereinbefore.

Finally in accordance with the invention there is proposed a bite wall which is adapted for fixing on the side of the impression tray, that is remote from the respective impression side, and which preferably comprises an identical thermoplastic material to the impression tray.

In a method proposed according to the invention for the preparation of an individually formed dental impression tray having a spacer layer, in particular an impression tray as described hereinbefore, for fine impression, there are provided the following steps which—insofar as technically possible—can optionally also be performed in another sequence or supplemented by further steps (first adaptive forming of the tray has occurred):

i) removal of the spacer layer, at least in the regions of the structures intended for the fine impression;

ii) optional introduction of a bonding agent to the structures of the impression tray, that are intended for fine impression (it is optionally possible to dispense therewith if there are sufficient retention elements); and

iii) introduction of a runny impression material (for example a silicone or polyether) into the regions of the impression tray, intended for the fine impression.

An advantage of the invention is that a first impression and a second or fine impression and possibly also the step of determining jaw relationship can be carried out in one patient session, whereby it is also possible to avoid time-consuming intermediate transport movements between the dental practice and the laboratory.

In that case it is possible to achieve an excellent quality in terms of fine impressions; comparable to the conventional, substantially more costly and elaborate methods.

The adaptive forming and impression process is more pleasant for the patient by virtue of the impression tray which is individual and therefore anatomically better adapted to the patient.

If the adaptive forming operation has not taken place satisfactorily the impression tray according to the invention can be heated again and the forming operation can be corrected as often as may be desired.

In general many sources of error as occur with the present impression methods can be eliminated by the method according to the invention and by the impression tray according to the invention.

By virtue of the fact that the conventional metal tray is eliminated and the impression tray according to the invention is a patient-individual part the complication and expenditure for storage and sterilization of the classic trays is reduced. It cannot then happen for example that a tray which is actually optimum for one patient is precisely not available because it has not yet been sterilized. In addition certain hygiene risks are avoided from the outset.

Finally the concept according to the invention reduces the amount used of the high-grade fine impression materials of silicone or polyether and it is therefore economically highly advantageous—also having regard to the significant saving in terms of working and transport steps—.

The invention is described in greater detail hereinafter by means of the embodiments by way of example illustrated in the drawings in which:

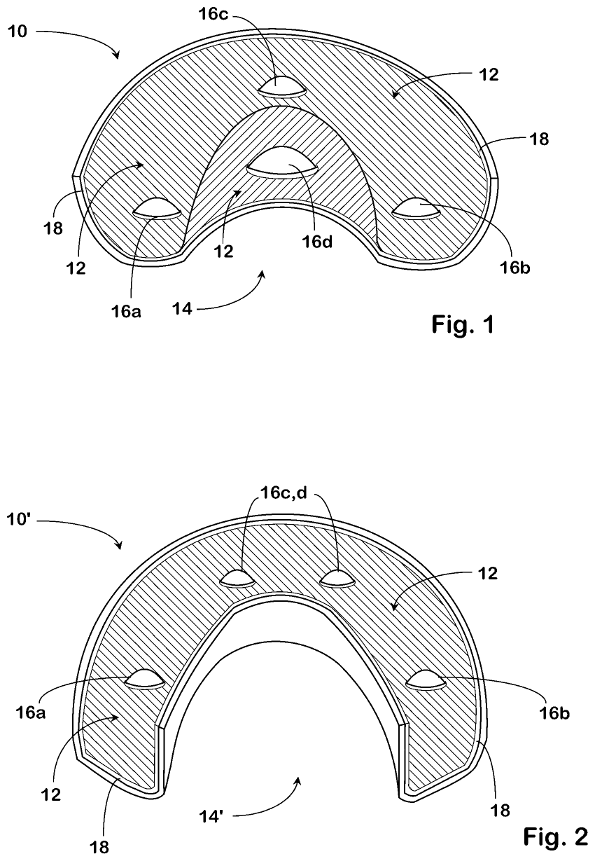

FIG. 1 shows a diagrammatic view of an impression tray according to the invention for upper jaw impressions;

FIG. 2 shows a diagrammatic view of an impression tray according to the invention for lower jaw impressions;

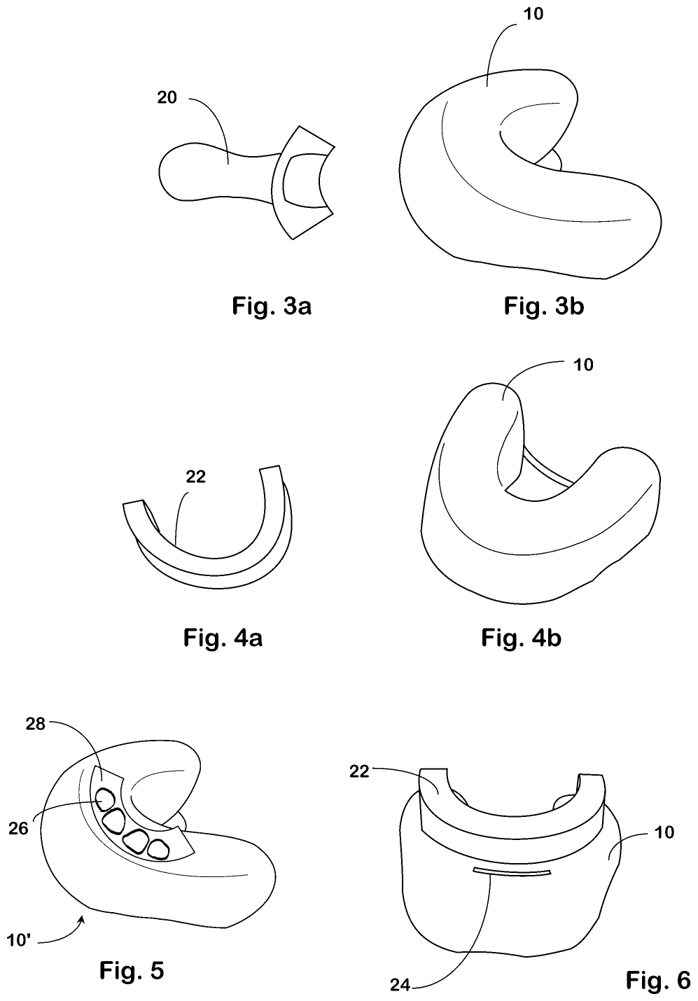

FIGS. 3a, b show an impression tray according to the invention with tray handle removed;

FIGS. 4a,b show an impression tray according to the invention with a bite wall still unfixed;

FIG. 5 shows a diagrammatic view of an impression tray for explaining a fixing counter-bite;

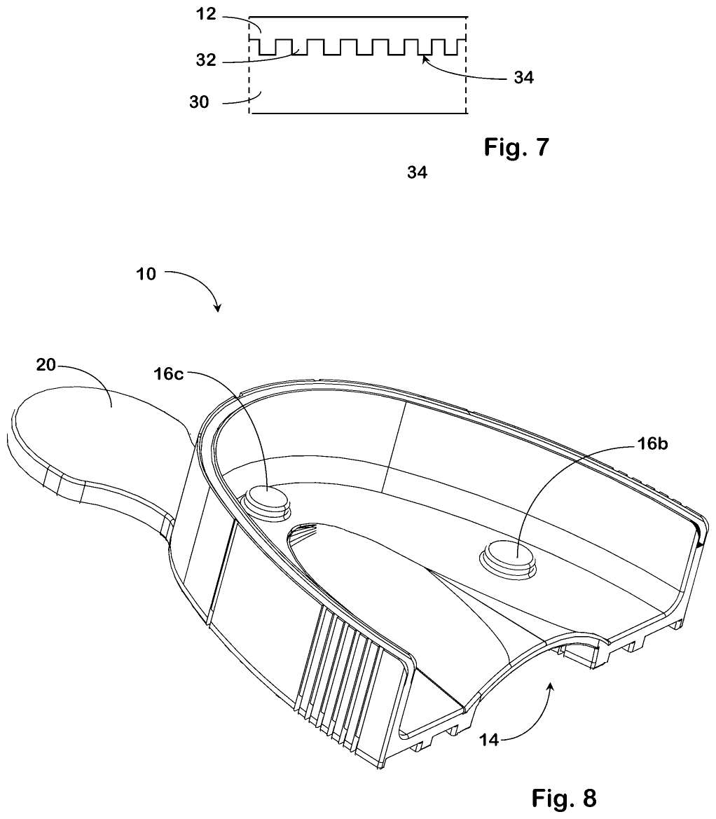

FIG. 6 shows an impression tray according to the invention with fixed bite wall;

FIG. 7 shows a diagrammatic layer structure for explaining the introduction of retention elements; and

FIG. 8 shows a perspective view of a further embodiment of an impression tray for upper jaw impressions.

FIG. 1 diagrammatically shows an impression tray 10 according to the invention for an upper jaw impression, visible on a central curvature 17 to ensure a free space for the tongue and as an anatomical base structure for impression of the palate.

A corresponding impression tray 10′ according to the invention for the lower jaw as shown in FIG. 2 in contrast, instead of the curvature 14, has a recess 14′ for the tongue. The view of the impression tray 10 in FIG. 1 corresponds to the position of use in the mouth of the patient; the impression tray 10′ in FIG. 2 has to be turned through 180° in relation thereto.

The impression tray 10, 10′ substantially comprises a thermoplastic material, the molten state of which is already achieved at temperatures which permit the material to be allowed to set in the mouth of a patient with at the same time adaptive forming thereof. Typical starting temperatures are for example around barely 70° C. Those temperatures can be relatively accurately predetermined for example in a temperature-controlled water bath. The surface temperatures of the heated thermoplastic material—as already stated hereinbefore—typically remain at or below the critical limit of 41° C. (preferably not more than 38° C.) in the mouth of the patient.

The impression tray 10, 10′ can be provided ready-made in different sizes for the dentist or operator. It is however also possible that the dentist or operator with knowledge of the tooth or jaw geometry of a patient beforehand prior to insertion into the mouth of the patient firstly adapts the impression tray extraorally approximately to the patient circumstances by heating, whereupon further heating is required for the actual forming operation.

The impression tray 10, 10′ can be produced by milling, pressing, cutting or stamping operations. A 3D printing process would also be conceivable, in which case such a 3D printing could basically also be effected by the operator for adaptation to specific patient requirements. The better the impression tray 10, 10′ is already previously adapted to the jaw and bite anatomy of the patient, the corresponding lesser modifications are required in the forming operation within the setting time available.

The illustrated impression tray 10, 10′ is covered on its side towards the structures to be molded with a spacer layer 12, the surface of which is emphasized by being visually darker in the drawings. This can involve a foam rubber layer or a sandwich arrangement comprising a plurality of aluminum films (or another material with the correspondingly required material properties). The spacer layer is of a respective given predetermined thickness which can be seen at the edge of the impression tray 10, 10′ at 18.

The spacer layer 12 is fixed for example with an adhesive glue to the tray surface in such a way that it is held fast and comply with deformations of the tray material within certain limits, but on the other hand can be removed substantially without leaving a residue.

The spacer layer 12 can already be connected to the tray material in the delivery state. It is however also possible for a dentist or another person to apply the spacer layer 12 only after a certain extraoral pre-forming of the impression tray 10, 10′, which has the advantage that the spacer layer 12 does not have to be pre-formed with the tray in the pre-forming thereof and as a result there are no folds or creases or the like. In the event of separate preparation of the film forming the spacer layer it is preferably self-adhesively applied to a siliconized or waxed carrier material.

In order to ensure a certain reserve of material in the adaptive forming operation and to permit simple removal of the spacer layer 12 it can project beyond the edge of the impression tray (see reference 18) (not shown).

In addition tray handles (see reference 20 in FIG. 3a) are formed on the impression trays 10, 10′ at the rear in FIGS. 1 and 2 (and therefore not visible).

The possibly pre-adapted impression tray 10, 10′ together with the spacer layer 12 is heated for example in a water bath to a predetermined temperature (desirably the tray handle region is not also heated in that case so that it remains firm) and is then adaptively formed as much as possible to the structures to be molded by the operator in the mouth of the patient by mechanical deformation.

In order later to achieve reproducible positioning even with the spacer layer 12 removed four stops 16a-d are respectively provided as shown in FIGS. 1 and 2. In this case these involve round openings in the spacer layer 12, through which extend raised portions from the tray material. In the molten state the respective tooth or jaw structures are replicated in those raised portions. As the raised portions of the stops 16a-d remain even after removal of the spacer layer 12 they then establish the position of the impression tray by way of four contact points and thus more than uniquely.

In order to fix the impression tray 10, 10′ more precisely for the fine impression without the operator having to hold the tray fast for the fine impression operation and without the patient having to keep the mouth wide open the operator, as shown by the diagrammatic view in FIG. 5 (the view is only shown by way of example with reference to FIG. 5; that measure can be provided in all illustrated variants of the impression tray) asks the patent, in the adaptive forming operation, that is to say with the thermoplastic tray material still being deformable, to bite into the side opposite to the actual molding side of the tray 10′, with a light to medium pressure, so that a bite impression is plastically impressed on the substantially flat surface provided there, or a bite impression is thereby produced, as indicated by reference 26 in FIG. 5. That provides an additional fixing point for, when the patient in the later fine impression operation again bites with a light pressure the opposite-jaw bite or counter-bite holds the tray fast even in regard to possible tilting moments, by way of the impression 26, in such a way that the operator does not need to additionally hold it fast, during the hardening phase of the fine impression procedure, or at least no longer over the entire time, and the patient can completely or substantially close the mouth. In addition the counter-bite provides an optimum and constant application of force for the fine impression, as generally could not be achieved by an operator by manually applying pressure.

In order to prevent the patient from biting through the thermoplastic material in the above-described “counter-bite molding operation”—which could lead to mechanical instability of the tray or leakages in the fine impression operation—and to avoid thermoplastic material penetrating into the interdental spaces of the counter-bite—and possibly also to provide a certain thermal insulation—a separation layer 28 is further applied in the expected region of the counter-bite as shown in FIG. 5, which separation layer can for example involve a fabric which is fixed near the surface. In that case introduction of the counter-bite impression 26 is not adversely affected by that separation layer 28, but in the counter-bite situation the patient does not come into direct contact with the thermoplastic material and can also not readily bite through same.

Accordingly dental fine impression is effected by means of the individually adaptable impression tray, preferably with the following steps which can be modified in respect of their sequence and which can possibly also be supplemented by intermediate steps:

a) providing an impression tray 10, 10′ approximately matching the jaw structure to be molded, with a spacer layer 12, and heating the impression tray until it becomes plastic;

b) adaptive forming of the impression tray 10, 10′ to the bite or jaw structure to be molded, with possibly formation or forming of the edge into the so-called membrane fold;

b1) optionally taking a counter-bite impression into the still shapeable thermoplastic material by the patient being asked to bite shut with a light or medium pressure; that step can also be carried out at the beginning of the forming step b) or any time during the forming operation;

c) removing the spacer layer 12 at least in the regions relevant for the fine impression, after removal of the impression tray from the mouth of the patient;

d) optionally introducing a bonding agent if that is not superfluous by virtue of mechanical retention elements;

e) introducing a runny impression material into the regions relevant for fine impression;

f) fitting the furnished tray into the mouth of the patient;

f1) if a counter-bite impression is present in accordance with step b1) fixing the impression tray during the hardening phase of the fine impression material by the patient biting shut, and

g) after hardening of the fine impression material removal of the fine impression.

FIGS. 3a and 3b show removal, which is desirable for producing a bite register, of the tray handle 20 from the impression tray 10 as in that situation the handle 20 would be a nuisance.

As shown in FIGS. 4a and 4b a bite wall 22 is provided for fixing on the impression tray 10. The connection is made either by means of thermoplastic fusing or other fixing means (for example adhesive, screws). FIG. 6 shows the connected state, in which it is also possible to see the former fixing location 24 of the handle 20.

If the bite wall 22 is made from the thermoplastic material of the impression tray then it is—preferably targetedly—heated, whereupon bite registration is effected. However other bite walls are also conceivable comprising other inelastically deformable materials, for example certain wax materials.

FIG. 7 shows a diagrammatic layer structure to illustrate the possibility of creating retention elements in the thermoplastic material 30 for the later fine impression, by structures in the spacer layer 12 firstly arranged on the thermoplastic material 30. In the example in FIG. 7 the spacer layer at its side adjoining the thermoplastic material 30 has an embossing with rectangular grooves 32, in which respect it will be appreciated however that this is only intended to represent an example of a possible structure. That groove structure 32 continues to exist when the spacer layer 12 is removed prior to the fine impression operation. By virtue of the structure 32 introduced in that way the fine impression material involves retention structures so that upon removal of the tray 10, 10′ after the fine impression operation the fine impression material remains fixedly joined to the tray without a separate bonding agent being required.

In addition as shown in FIG. 7 the side of the spacer layer adjoining the thermoplastic material 30, at 34, can have a possible coloring, a pattern and/or an inscription. That shows through when the thermoplastic material 30 is transparent and thus formable and becomes invisible upon hardening and thus allows optimum visual temperature control.

FIG. 8 shows a perspective view of a further embodiment of an impression tray 10 according to the invention for the upper jaw (without spacer layer), in which there are provided three stops (stops 16a-c, of which the stop 16a is not visible).

1. Individually adaptable dental impression tray for dental fine impression,
wherein the impression tray is formed substantially from a thermoplastic plastic which in the heated state permits forming of the impression tray in the mouth of a patient and which is dimensionally stable in the cooled state,
wherein the impression tray at least in partial regions in which fine impression is to be effected has a spacer layer of a predetermined thickness, wherein the spacer layer is completely or partially removable after the forming operation.

2. An impression tray as set forth in claim 1 wherein the spacer layer is of a thickness of between 0.1 and 50 mm, wherein said constant or variable thickness is adapted to the desired minimum layer thickness of a low-viscosity impression material to be introduced after removal of the spacer layer for the fine impression.

3. An impression tray as set forth in claim 1 wherein the spacer layer is formed from a material which is not thermoplastic in the use temperature range but which is generally elastically deformable.

4. An impression tray as set forth in claim 1 wherein on the side facing towards the thermoplastic material the spacer layer is colored and/or there are provided inscriptions and/or patterns, whereby improved optical assessability of a current degree of transparency of the thermoplastic material and thus of the current temperature and deformability of the thermoplastic material is made possible.

5. An impression tray as set forth in claim 1 wherein the spacer layer for providing one or more stops has at least one and preferably at least three openings, through which the thermoplastic material of the impression tray can pass directly to the tooth or jaw structures of which the impression is to be made.

6. An impression tray as set forth in claim 1 wherein the spacer layer for providing one or more stops has at least one non-penetrative recess, through which the thermoplastic plastic of the impression tray can pass closer to the tooth or jaw structures of which the impression is to be taken than in surrounding regions.

7. An impression tray as set forth in claim 5 wherein the thermoplastic plastic is pre-shaped in a raised configuration in the region of the at least one opening or recess to form the at least one stop.

8. An impression tray as set forth in claim 5 wherein at least three and preferably four stops are provided for an upper jaw impression tray and for a lower jaw impression tray.

9. An impression tray as set forth in claim 4 wherein there is provided at least one stop respectively in the two lateral regions of the dental arch of which the impression is to be taken and at least one stop in the central front ventral region of the dental arch from which the impression is to be taken.

10. An impression tray as set forth in claim 4 wherein the thermoplastic material and/or the spacer layer is adapted to provide at least one retention element for ensuring fixing of the fine impression layer in relation to adjoining impression tray structures upon later removal of the tray after the fine impression operation.

11. An impression tray as set forth in claim 1 wherein the spacer layer extends substantially—excluding possible openings for stops—over the entire region facing towards the upper or lower structures from which the impression is to be taken, wherein the spacer layer can project laterally beyond the impression tray in the non-adapted state thereof.

12. An impression tray as set forth in claim 1 wherein introduced into the thermoplastic plastic are defined perforations at least in partial regions, which perforations can be covered by the spacer layer.

13. An impression tray as set forth in claim 1 wherein it has a separable tray handle which is connected to the impression tray base and which is formed either from the thermoplastic plastic of the impression tray or from another material.

14. An impression tray as set forth in claim 1 wherein at the side in opposite relationship to the jaw structures from which the impression is to be taken the impression tray has regions which in the deformable state of the plastic can be deformed by the opposite jaw bite in such a way that a reproducible position of the impression tray for a later fine impression step is defined thereby.

15. An impression tray as set forth in claim 14 wherein at the side in opposite relationship to the jaw structures from which the impression is to be taken the impression tray has a separation layer at the surface or near the surface at least in partial regions.

16. An impression tray as set forth in claim 15 wherein the separation layer is of such a configuration as to prevent penetration of thermoplastic material into interdental spaces of the opposite jaw and/or completely biting through the thermoplastic material by the opposite jaw.

17. An impression tray as set forth in claim 1 wherein for the purposes of determining jaw relationship the impression tray is adapted for fixing a bite wall, wherein fixing of the bite wall is effected on the side remote from the respective impression side and wherein the bite wall is formed from the thermoplastic plastic of the impression tray or another inelastic material.

18. A thermoplastic base element for an individually adaptable impression tray as set forth in claim 1 wherein the thermoplastic base element includes at least the impression tray of thermoplastic plastic with or without a tray handle but without a spacer layer, wherein the base element is adapted for application of a spacer layer prior to the forming operation, possibly with predetermination of suitable positions for stops, wherein when positions for stops are predetermined those stops are already provided in the base element in the form of convex elements.

19. A spacer layer for an individually adaptable impression tray as set forth in claim 1 wherein the spacer layer is adapted for releasable application to a thermoplastic base element.

20. A bite wall for an individually adaptable impression tray as set forth in claim 1 wherein the bite wall is adapted for fixing on the side of the impression tray, remote from the respective impression side.

21. A method of preparing an individually formed dental impression tray as set forth in claim 1, for fine impression, comprising:
removing the spacer layer, at least in the regions of the structures intended for a fine impression;
optionally introducing a bonding agent on the structures of the impression tray, intended for the fine impression; and
introducing a low-viscosity impression material into the regions of the impression tray intended for the fine impression.
